(19) United States
(12) Patent Application Publication
(10) Pub. No.: US 2013/0037135 A1
(43) Pub. Date: Feb. 14, 2013

(54) DUAL-SOURCE WATER SYSTEMS

(71) Applicants: Andrew Eide, Rockwall, TX (US); Joseph P. Urso, Dallas, TX (US)

(72) Inventors: Andrew Eide, Rockwall, TX (US); Joseph P. Urso, Dallas, TX (US)

(21) Appl. No.: 13/209,209

(22) Filed: Aug. 12, 2011

(51) Int. Cl. F16K 15/00

(52) U.S. Cl. 137/512; 137/545

(57) ABSTRACT

Dual-source water systems may include a selectively controllable mechanism for receiving water from a direct line connection or from a water containment apparatus. The system also may include a filtration system, wherein water may flow through the selectively controllable mechanism to the filtration system. The selectively controllable mechanism may be a valve system and may include a transition switch to switch between water flowing from the direct line connection or from the water containment apparatus.

### TECHNICAL FIELD

The present disclosure generally relates to water systems and, in particular, to dual-source water systems.

### BACKGROUND

Water generally is treated in an economical and convenient manner before provided for drinking by people. Systems have been developed, such as water coolers or dispensers, to provide drinking water for home or office use without a user drinking water directly from the faucet and/or without having to buy individual bottles of purified water. Water for these systems may originate from a public water system, a private well, or even a plastic bottle.

### SUMMARY

Embodiments of the present disclosure generally provide dual-source water systems to provide drinking water in an effective, efficient, and cost-sensitive manner.

Embodiments of the present disclosure may provide a dual-source water system that may include a first water source originating from a direct water line and feeding into a filtration system through a first line having a first valve, and a second water source originating from a water containment apparatus and feeding into the filtration system through a second line having a second valve. Water may be drawn from the second water source using a feed pump. The first valve and second valve may be T-valves. A 3-way valve also may comprise the first valve and the second valve. The system may also include a transition switch. The filtration system may a KDF filter, an UF membrane, a carbon filter, and a sediment filter.

Other embodiments of the present disclosure may provide a valve system for controlling a dual-source water system that may include a first valve controlling a first water source and a second valve controlling a second water source. The first valve and the second valve may be selectively controllable dependent on whether water originates from the first water source or the second water source. The first valve and the second valve may be selectively controllable through a transition switch. The first valve and the second valve may be T-valves or form parts of a 3-way valve. The first and second valves may be check valves, each having a dedicated line connection from the first or second water source to a filtration system.

Embodiments of the present disclosure also may provide a dual-source water system including a selectively controllable mechanism for receiving water from a direct line connection or from a water containment apparatus and a filtration system, wherein water may flow through the selectively controllable mechanism to the filtration system. The filtration system may include a KDF filter, an UF membrane, a carbon filter, and a sediment filter. The system also may include a float switch to control water level in a reservoir tank coupled to the filtration system. Water may be drawn up from the water containment apparatus using a feed pump.

The selectively controllable mechanism may be a valve system having a first T-valve associated with the direct line connection and a second T-valve associated with the water containment apparatus. The selectively controllable mechanism may be a first line and a first check valve associated with the direct line connection and a second line and a second check valve associated with the water containment apparatus. The selectively controllable mechanism may be a valve system including a 3-way valve. The selectively controllable mechanism may include a transition switch.

### BRIEF DESCRIPTION OF THE DRAWINGS

For a more complete understanding of this disclosure and its features, reference is now made to the following description, taken in conjunction with the accompanying drawing, in which:

FIG. 1 depicts a dual-source water system according to an embodiment of the present disclosure.

### DETAILED DESCRIPTION

The present disclosure generally is directed to dual-source water systems provided in an effective, efficient, and cost-sensitive manner. Systems formed according to embodiments of the present disclosure may include more than one means or structure for receiving incoming water to be dispensed to a user as drinking water. Such means or structure may include, but are not necessarily limited to, a direct water connection line or a water bottle. As each means is available and connected to the system, users of dual-source water systems according to embodiments of the present disclosure may switch between water available from the direct water connection line and water available from a water containment apparatus.

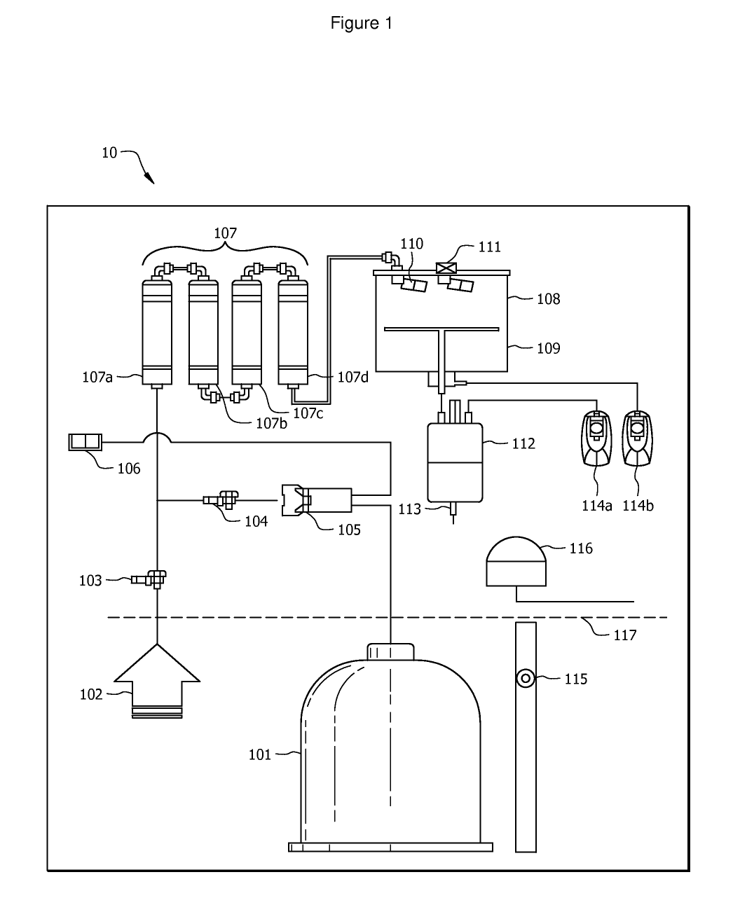

FIG. 1 depicts dual-source water system 10 according to an embodiment of the present disclosure. Water to be utilized in dual-source water system 10 may originate from water containment apparatus 101 or from water line 102.

Water line 102 may provide water from a direct connection to various water sources, such as a municipal or non-municipal source, a tap, a well, or other water source that may be accessible through a line connection. According to embodiments of the present disclosure, water may enter dual-source water system 10 through water line 102 and first T-valve 103 may be employed to control the flow of water into dual-source water system 10 from water line 102. When first T-valve 103 is in an open position and second T-valve 104 is in a closed position, water may enter dual-source water system 10 from water line 102; however, when first T-valve 103 is in a closed position, no water may flow from water line 102 into system 10 but water may be drawn from water containment apparatus 101 as will be discussed in more detail below.

First T-valve 103 may be installed in dual-source water system 10 using a bracket. However, other mechanisms of installation may be utilized without departing from the present disclosure. While dual-source water system 10 has been depicted as including both first T-valve 103 and second T-valve 104, it should be appreciated that first T-valve 103 and second T-valve 104 may be substituted with a single 3-way valve permitting a user to switch between water sources without departing from the present disclosure. Further, it should be appreciated that first T-valve 103 and second T-valve 104 may be any manual, automatic, electrical, mechanical, or electromechanical means to restrict or allow water to flow through dual-source water system 10. In addition, first T-valve 103 and second T-valve 104 or any valve-type mechanism incorporated into system 10 to switch between water sources may be manually operable or controlled by other means, such as electrical, mechanical, computer or otherwise without departing from the present disclosure.

According to embodiments of the present disclosure, water also may enter dual-source water system 10 through a connection to water containment apparatus 101. Water containment apparatus 101 may be a water bottle, such as a 5-gallon water bottle; however, it should be appreciated that water containment apparatus 101 may be any container that provides for water to be drawn up into dual-source water system 10 using a pumping mechanism according to embodiments of the present disclosure. It also should be appreciated that water containment apparatus 101 may hold water originating from a variety of sources, including but not necessarily limited to, a tap water source, a municipal or non-municipal source, a well, or any other external water source. Water held in water containment apparatus 101 may have already been filtered or it may be unfiltered in nature, thereby necessitating filtration prior to being made available to a user for drinking purposes. Water may enter dual-source water system 10 from water containment apparatus 101 when second T-valve 104 may be in an open position and first T-valve 103 may be in a closed position. Water may be drawn up from water containment apparatus 101 via operation of feed pump 105. Feed pump 105 may include a check valve function to prevent water from flowing backward to water containment apparatus 101 such as when water may be drawn up into system 10 via water line 102.

It should be appreciated that dual-source water system 10 may include transition switch 106 that may direct whether water enters dual-source water system 10 from water line 102 or water containment apparatus 101. When transition switch 105 is in an “on” position, water may enter dual-source water system 10 from water containment apparatus 101. However, when transition switch 105 is in an “off” position, water may enter dual-source water system 10 via water line 102.

A dual-source water system according to embodiments of the present disclosure may be incorporated into any exterior housing suitable for dispensing water. For example, the exterior housing may be a portable unit, not needing to be mounted to a wall or any other support. In another embodiments of the present disclosure, the dual-source water system may be part of a housing that may be mounted to a wall to provide for easier attachment to an external water line, for example.

Lower compartment 117 of the housing may be provided within dual-source water system 10 to accommodate access to water containment apparatus 101 and/or water line 102. Lower compartment 117 may be opened, such as by opening a pivoting door for example, to access or replace water containment apparatus 101. Such lower compartment 117 may include door switch 115. When door switch 115 is in a closed position, feed pump 105 may not be in operation. However, when door switch 115 is in an open position, feed pump 105 may operate to build pressure in the line where second T-valve 104 may be positioned such that water may be drawn up from water containment apparatus 101 to flow into filtration system 107.

While dual-source water system 10 has been described as utilizing a valve system including first T-valve 103 and second T-valve 104, it should be appreciated that a 3-way valve may be substituted to regulate flow and switching between water line 102 and water containment apparatus 101 for these T-valves according to embodiments of the present disclosure. In other embodiments of the present disclosure, such a valve system may be altered to provide independent connections from water line 102 and water containment apparatus 101 flowing into filtration system 107. Such a system may include one connection line and one check valve dedicated to water line 102 and a second connection line and a second check valve dedicated to water containment apparatus 101. It also should be appreciated that dual-source water system 10 may be modified to include dedicated pumps connected to, or in fluid communication with, each of the water sources. Accordingly, there may be one pump associated with water line 102 and a second pump associated with water containment apparatus 101.

Regardless whether water flows through dual-source water system 10 through water line 102 or water containment apparatus 101, once water has passed through first T-valve 103 or second T-valve 104, water may flow to filtration system 107. According to embodiments of the present disclosure, filtration system 107 may be comprised of several components that may filter water from either of the dual sources for drinkability over several stages.

In certain embodiments of the present disclosure, kinetic degradation fluxion (KDF) filter 107a may be incorporated as part of filtration system 107. KDF filter 107a may be used in pre-treatment and primary treatment applications to supplement or replace existing technologies to extend system life and/or to reduce heavy metal contamination. KDF filter 107a is a high-purity copper-zinc formulation that uses oxidation/reduction to remove chlorine, lead, mercury, iron and hydrogen sulfide from water supplies.

KDF filter 107a may operate through an oxidation/reduction mechanism. In such a mechanism, electrons may be exchanged with contaminants, whereby the contaminants may be converted into harmless components. Electrons may be transferred between molecules, and new compounds may be created. For example, KDF filter 107a may change free chlorine sometimes present in water into benign, water-soluble chlorine salt, which may be carried harmlessly through dual-source water system 10. Heavy metals, such as copper, lead and mercury, may react and bond with the surface of KDF filter 107a medium and be removed from the water supply.

KDF filter 107a may be utilized particularly when there may be a possibility that heavy metals may be present in water coming through dual-source water system 10. Heavy metals may be present, for example, when water from non-municipal sources (which may not have to meet certain safety standards, such as EPA standards) may enter dual-source water system 10 through water line 102.

KDF filter 107a may be incorporated into filtration system 107 to work in conjunction with more traditional carbon filter 107b as depicted in FIG. 1. Carbon filter 107b generally may operate through an adsorption mechanism. Carbon filter 107b may include granular activated carbon filters, as well as carbon block or inline filters. Use of KDF filter 107a in conjunction with carbon filter 107b may prolong the life of carbon filter 107b, as KDF filter 107a often may last more than 5 years with proper handling, while carbon filter 107b may sometimes only last less than one year. KDF filter 107a in conjunction with carbon filter 107b may increase the effectiveness of carbon filter 107b by reducing chlorine build-up. KDF filter 107a also may supplement carbon filter 107b by removing heavy metals that carbon filter 107b often may not remove.

Alternatively, KDF filter 107a may be used in place of carbon filter 107b. KDF filter 107a may replace carbon filter 107b in circumstances, for example, when bacteria and algae may be more prevalent, as KDF filter 107a may be more likely to control both bacteria and algae while carbon filter 107b sometimes may have a tendency to permit growth of bacteria and algae. However, it should be appreciated that carbon filter 107b may improve the taste of water being passed through dual-source water system 10 as it may remove the chlorine taste from the water.

It should be appreciated that KDF filter 107a may be used in reverse osmosis (RO), deionization (DI) as well as ion exchange systems (IX). For example, KDF filter 107a may protect RO systems from chlorine degradation and bacterial contamination. KDF filter 107a also may tend to protect IX systems from becoming contaminated with chlorine, algae, fungi and bacteria.

In certain embodiments of the present disclosure, ultrafiltration (UF) membrane 107c may be another component of filtration system 107. UF membrane 107c may be utilized when water entering dual-source water system 10 may originate from non-municipal sources. Such water may possibly contain biologics or other germs when the water has not been treated with chlorine, for example. However, UF membrane 107c may be used with water from municipal or other sources without departing from the present disclosure.

UF membrane 107c may allow dual-source water system 10 to filter any undesirable materials from water prior to making such water available to a user to consume. Ultrafiltration may be effective for the removal of colloids, proteins, bacteria, viruses, parasites, organic and inorganic polymeric molecules and other organic molecules having a particle size of 0.1 micron or larger. In ultrafiltration, water and low molecular weight substances may permeate a member while particles, collods, and macromolecules may be retained through size exclusion.

Embodiments of the present disclosure may include sediment filter 107d as part of filtration system 107. Sedmiment filter 107d may be helpful to incorporate into filtration system 107 to assist in removal of larger particles and pollutants, such as dirt, sand and some heavy metals, from water passing through dual-source water system 10.

Filtration system 107 has been described as having four components; however, it should be appreciated that filtration system 107 may operate to filter water through dual-source water system 10 without one or more of these components without departing from the present disclosure. It also should be appreciated that other filtration components may be added or substituted into filtration system 107 without departing from the present disclosure.

After water passing through dual-source water system 10 has been filtered through filtration system 107, water then may be transferred to reservoir tank 108 and made available for consumption by a user. Reservoir tank 108 also may include cold tank 109, should dual-source water system 10 be used for dispensing cold water to a user. Cold tank 109 may comprise a portion of reservoir tank 108. As an example, if reservoir tank 108 holds 3.2 liters of water, cold tank 109 may hold 2.0 liters of water.

Reservoir tank 108 may include one or more of ball top 110 that may provide an indication as to the water level in reservoir tank 108 and allow for adjustment of the water distribution. Ball top 110 may work in conjunction with float switch 111. Float switch 111 may be used to determine if water containment apparatus 101 is empty and accordingly turn feed pump 105 off or on. When float switch 111 is turned on, reservoir tank 108 may be filled upon determining that the water level within reservoir tank 108 is below a desired level. When float switch 111 is turned off, only water originating from water line 102 may be drawn into dual-source water system 10. Reservoir tank 108 also may be connected to hot tank 112 which may include hot water drain 113 to make hot water available to a user.

When dual-source water system 10 is in operation, a user may manipulate one of two faucets 114a, 114b positioned on the exterior housing of system 10. If hot water faucet 114a has been selected, hot water may be delivered to a user via hot tank 112. It should be appreciated that water may be maintained in hot tank 112 for use when hot water faucet 114a is selected. Alternatively, water may flow downward from reservoir tank 108 to hot tank 112 at the time when hot water faucet 114a has been selected. If cold water faucet 114b has been selected, water may flow directly from cold tank 109 of reservoir tank 108 to cold water faucet 114b for distribution to a user. While system 10 has been described as including two faucets, it should be appreciated that system 10 may include a single faucet or more than two faucets without departing from the present disclosure.

Further, although not depicted in FIG. 1, dual-source water system also may include an ultraviolet lamp. Such an ultraviolet lamp may provide for additional purification of water through natural disintegration of potentially unsafe microorganisms. Water that may pass through first T-valve 103 or second T-valve 104 may be subjected to a strong source of ultraviolet rays at any desired stage in making the water passing through system 10 available for drinking.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A dual-source water system comprising:
a first water source originating from a direct water line and feeding into a filtration system through a first line having a first valve; and
a second water source originating from a water containment apparatus and feeding into said filtration system through a second line having a second valve.

2. The dual-source water system of claim 1, wherein water is drawn from said second water source using a feed pump.

3. The dual-source water system of claim 2, wherein said feed pump is controlled through a door switch.

4. The dual-source water system of claim 1, wherein said first valve and said second valve are T-valves.

5. The dual-source water system of claim 1, wherein a 3-way valve comprises said first valve and said second valve.

6. The dual-source water system of claim 1, said system further comprising a transition switch.

7. The dual-source water system of claim 1, wherein said filtration system includes a KDF filter, an UF membrane, a carbon filter, and a sediment filter.

8. A valve system for controlling a dual-source water system comprising:
a first valve controlling a first water source; and
a second valve controlling a second water source, wherein said first valve and said second valve are selectively controllable dependent on whether water originates from said first water source or said second water source.

9. The valve system of claim 8 wherein said first valve and said second valve are selectively controllable through a transition switch.

10. The valve system of claim 8 wherein said first valve and said second valve are T-valves.

11. The valve system of claim 8, wherein a 3-way valve comprises said first valve and said second valve.

12. The valve system of claim 8 wherein said first valve and said second valve are check valves, each having a dedicated line connection from said first or second water source to a filtration system.

13. A dual-source water system comprising:
a selectively controllable mechanism for receiving water from a direct line connection or from a water containment apparatus; and
a filtration system, wherein water flows through said selectively controllable mechanism to said filtration system.

14. The dual-source water system of claim 13, wherein said selectively controllable mechanism is a valve system having a first T-valve associated with said direct line connection and a second T-valve associated with said water containment apparatus.

15. The dual-source water system of claim 13, wherein said selectively controllable mechanism is a first line and a first check valve associated with said direct line connection and a second line and a second check valve associated with said water containment apparatus.

16. The dual-source water system of claim 13, wherein said selectively controllable mechanism is a valve system including a 3-way valve.

17. The dual-source water system of claim 13, said filtration system including a KDF filter, an UF membrane, a carbon filter, and a sediment filter.

18. The dual-source water system of claim 13, said system further comprising:
a float switch to control water level in a reservoir tank coupled to said filtration system.

19. The dual-source water system of claim 13, wherein said selectively controllable mechanism includes a transition switch.

20. The dual-source water system of claim 13, wherein water is drawn up from said water containment apparatus using a feed pump.
